(19) United States
(12) Patent Application Publication
(10) Pub. No.: US 2023/0278524 A1
(43) Pub. Date: Sep. 7, 2023

(54) BELT RETRACTOR

(71) Applicant: AUTOLIV DEVELOPMENT AB, Vargarda (SE)

(72) Inventors: Adrian BUD, Dalsjöfors (SE); Arndt SÖHNCHEN, Hamburg (DE); Lennart PETTERSSON, Vargarda (SE); Ronald JABUSCH, Elmshorn (DE); Hans-Jörg LANGHOFF, Bönningstedt (DE); Antto-Christian GLAESSER, Hasloh (DE); Alexandru CIRSTEA, Elmshorn (DE); Elias MATHIASSON, Alingsas (SE); Jens EHLERS, Horst (DE); Janne LARSSON, Sollebrunn (SE); Per AXBLOM, Alingsas (SE)

(21) Appl. No.: 18/043,871

(22) PCT Filed: Aug. 30, 2021
(86) PCT No.: PCT/EP2021/073832

§ 371 Date: Mar. 2, 2023

(30) Foreign Application Priority Data
Sep. 7, 2020 (DE) 10 2020 211 209.6

(51) Int. Cl. B60R 22/46

(52) U.S. Cl. CPC B60R 22/4604; B60R 2022/4666

(57) ABSTRACT

The invention relates to a belt retractor surrounding a belt reel which is rotatably mounted in a frame, and comprising a force-limiting device with at least one plastically deformable first torsion rod, wherein the first torsion rod has a first end rotationally fixed to the belt reel and a second end rotationally fixed to a profiled head which can be blocked via a first blocking device in a fixed manner relative to the vehicle. The belt reel, the first torsion rod and the profiled head are arranged coaxially to one another and in series relative to one another.

The present invention relates to a belt retractor having the features of the preamble of Claim 1.

Belt retractors have as basic components a load-bearing frame and a belt reel that is rotatably mounted in the frame and onto which a safety belt can be wound. The frame serves not only for mounting the belt reel but also for fastening the belt retractor to a seat structure or to a vehicle structure and, for this purpose, is made of a correspondingly thick steel sheet, which is bent into a U-shaped frame.

In addition, modern belt retractors are provided with force-limiting devices for reducing the occupant loading that enable a force-limited belt strap pull-out in the event of an accident until the occupant is caught by an airbag, for example. For this purpose, plastically deformable torsion rods have proven themselves effective and at one end are rotationally fixed to the belt reel and at the other end are fixed to a part (profiled head) which can be blocked via a first blocking device in a fixed manner relative to the vehicle in the event of an accident. In such a torsion rod, the force-limiting level of the force-limited belt strap pull-out is predetermined by its plastic deformation limit.

Publication DE 199 27 427 A1 discloses a belt retractor which has a two-stage torsion rod with two torsion sections having different plastic deformation limits. The two-stage torsion rod is rotationally fixed to the profiled head at the free end, which forms the end of the torsion portion having the higher force-limiting level. The other free end is rotationally fixed to the belt reel. Furthermore, a switchable second blocking device is provided with a torque tube, wherein the torque tube is connected in a profiled central portion to a profile of the torsion rod, which separates the two torsion portions from one another. Furthermore, the switchable second blocking device comprises two releasable blocking pawls, which block the torque tube relative to the frame of the belt retractor. Thus, the torsion portion having the lower plastic deformation limit, i.e., having the lower force-limiting level at the beginning of the force-limited belt strap pull-out, is bridged and the force-limited belt strap pull-out is made possible by a plastic deformation of the torsion portion having the higher plastic deformation limit at a higher force-limiting level. When the second blocking device is switched, the blocking of the torque tube is canceled, and the further force-limited belt strap pull-out is made possible by a plastic deformation of the torsion portion having the lower plastic deformation limit at the lower force-limiting level. The two-stage torsion rod is arranged together with the torque tube in a cavity of the belt reel, whereby a belt reel having a correspondingly large cavity and a correspondingly large outer diameter must be provided.

Furthermore, it is known to provide vehicle seats with integrated safety belt devices in which at least the belt retractors of the seat belt devices are fastened in the backrests of the vehicle seats. In this case, due to the lack of a load-bearing B-pillar and for reasons relating to access to the rear seats or for reasons relating to distance from the rear vehicle structure, the belt retractors are preferably integrated into the backrests of the vehicle seats, which must therefore also be designed to absorb the tensile forces acting in the case of restraint. The belt retractors themselves have all the basic components of a standard belt retractor and are equipped only with various additional subassemblies provided especially for installation in the backrest, such as a self-aligning inertia sensor. The installation into the backrests is problematic in that the available installation space is very small, and the backrests are not enlarged as desired for installation and cannot be changed as desired in their basic structure. In this case, the structure of the backrests is designed in particular for absorbing the restraining forces in the event of an accident with a framework made of braces, which are intended to form a structure which is as rigid as possible at the lowest possible dead weight. From this requirement, there is inevitably a structure—which can only be changed to a limited extent— having long struts that are as continuous as possible and that divide the interior of the backrest into a plurality of elongated free spaces.

In the case of belt retractors, in particular when they are provided for installation in backrests, This results in the problem that they have to be designed as compactly as possible and in particular also have to be designed for installation in very narrow and elongated installation spaces.

In order to achieve the object, a belt retractor with the features of Claim 1 is proposed. Further preferred embodiments can be found in the dependent claims, the figures and the associated description.

According to the basic idea of the invention, it is proposed that the belt reel, the first torsion rod and the profiled head are arranged coaxially to one another and in series relative to one another.

An elongated, narrow basic structure of the belt retractor can be realized by the proposed solution. Compared to solution known from the prior art, the first torsion rod is taken out of the belt reel and is arranged coaxially to the belt reel, so that the belt reel can be designed smaller in its outer diameter, because the previously required cavity in the belt reel for the arrangement of the torsion rod is omitted. Furthermore, the profiled head which can be blocked via a first blocking device in a fixed manner relative to the vehicle is likewise arranged coaxially to and in series relative to the belt reel, so that the profiled head is likewise released from the belt reel. Thus, the belt reel can also be dimensioned smaller for this reason, because the profiled head is no longer arranged directly on it. Furthermore, the coaxial series arrangement of the three basic components enables a very narrow and elongated basic structure of the belt retractor so that it can be arranged more easily in already existing narrow and elongated installation spaces of the backrest or of the vehicle structure. However, if the existing installation spaces are not sufficient, they can also be modified and adapted slightly.

The first torsion rod is preferably arranged in series between the belt reel and the profiled head. The first torsion rod practically forms the connection between the profiled head and the belt reel. When the profiled head is blocked, the second end of the first torsion rod is blocked, and the first end of the first torsion rod can rotate relative to the blocked profiled head together with the belt reel under a plastic deformation of the portion of the first torsion rod arranged between the first and the second end. This results in a simple and clear basic structure with a force flow that is as straight as possible so that the belt retractor can be designed to be very compact for the restraining forces to be absorbed.

It is further proposed that the profiled head and the belt reel are mounted at an axial distance from one another in separate radial bearings. In the previous arrangement of the profiled head on the belt reel, said profiled head at the same time formed the radial bearing of the belt reel, wherein the arrangement of the torsion rod and the radial bearing of the belt reel in the profiled head resulted in a comparatively large outer diameter of the belt reel. By virtue of the proposed separate radial bearing, the mounting of the belt reel can be implemented more easily and thus in a manner optimized for the installation space. In addition, the mounting can be rendered more stable as a result of the two bearings that are provided and the axial spacing of the radial bearings.

It is further proposed that the first torsion rod is held in a rotationally fixed manner with the first end in a receptacle of the belt reel that is open toward the axial outer side. The first torsion rod is thereby rotationally fixed to the first end on the outside of the belt reel and extends from the receptacle coaxially in the axial direction from the belt reel to the outside.

It is further proposed that at least one second torsion rod is arranged coaxially to and in series relative to the belt reel between the first torsion rod and the profiled head. By providing the second torsion rod, a higher or a lower force-limiting level of the force-limited belt strap pull-out can be realized depending on the type of activation.

The second and the first torsion rod can preferably have different plastic deformation limits, so that a stepped course of the force-limiting characteristic can be realized by a successive activation of the two torsion rods.

A torque tube can preferably be provided here which is fixed in relation to the belt reel in a rotationally fixed manner via a switchable second blocking device, wherein the torque tube connects the two mutually facing ends of the first torsion rod and of the second torsion rod to one another in a rotationally fixed manner. By means of the torque tube, the first torsion rod can be deliberately bridged to activate the second torsion rod in a first phase of the force-limitation. The first torsion rod is then activated by the switching of the second blocking device.

It is further proposed that an axially projecting protrusion is provided on the belt reel, in relation to which the torque tube is fixed via the switchable second blocking device. A force transmission surface on which the torque tube is supported is created on the belt reel by the axially projecting protrusion. Due to the arrangement of the protrusion, a force transmission surface is created in particular which does not increase the outer diameter of the belt reel, and the coaxial series arrangement of the torsion rods relative to the belt reel can be realized in a particularly simple manner.

The axial protrusion here can preferably be annular, and the torque tube can protrude radially inwardly into the axial annular protrusion or surround the axial annular protrusion radially on the outside. As a result, the torque tube additionally has a support in the radial direction and is mounted radially on the protrusion in particular after the switching and release of the second blocking device during the execution of the rotational movement.

It is further proposed that an axially projecting annular protrusion is provided on the profiled head, and the torque tube projects radially inwardly into the annular protrusion or surrounds the annular protrusion radially on the outside. The proposed solution is advantageous in that the torque tube finds a support on the profiled head via the annular protrusion and is mounted on the profiled head during the execution of a relative rotational movement. This is advantageous in particular due to the increased axial overall length of the belt retractor required by the solution according to the invention.

It is further proposed that the belt reel is designed as a solid shaft. As a result of the formation as a solid shaft, a particularly compact design having a simultaneously very high dimensional stability of the belt reel can be realized. For example, positive-locking designs corresponding to the coupling of the belt strap can be provided in the belt reel; in any case the cavity required heretofore for the arrangement of the torsion rod can be omitted. Furthermore, by designing the belt reel as a solid shaft, the axial receptacle for fixing the first end of the first torsion rod in a rotationally fixed manner can be realized particularly easily.

The invention is explained below using preferred embodiments with reference to the accompanying figures. The following are shown:

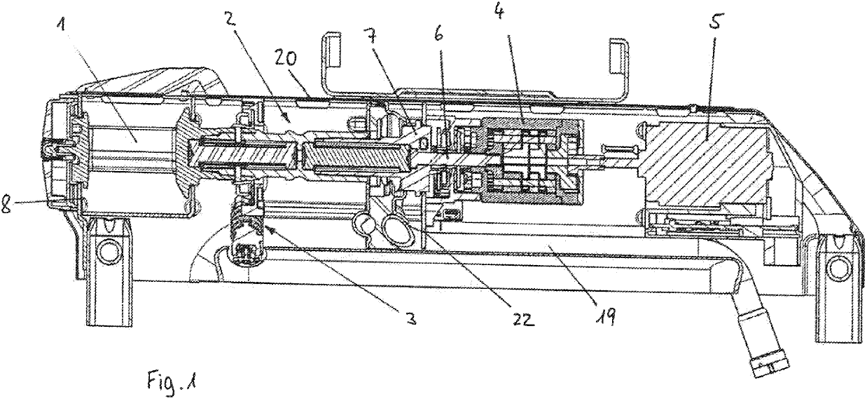

FIG. 1 shows a belt retractor with various additional subassemblies in a sectional view, and

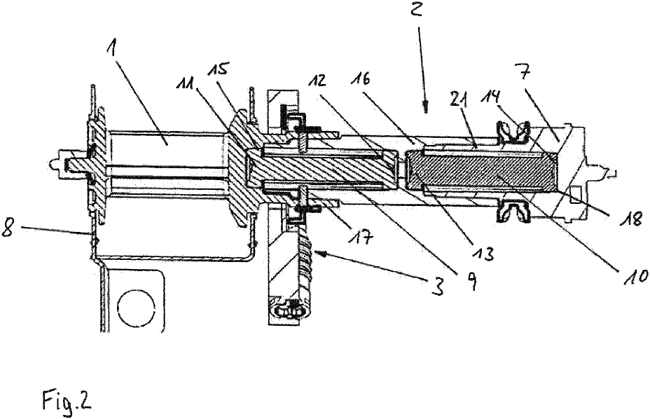

FIG. 2 shows the belt retractor with the force-limiting device.

FIG. 1 shows a belt retractor having a belt reel 1, which is rotatably mounted in a frame 8, which belt retractor is provided with various additional subassemblies. A force-limiting device 2, an electric motor 5, a transmission 4 and an irreversible pyrotechnic tightening device 19 are thus provided. The belt retractor is mounted with the frame 8 and the belt reel 1 mounted therein together with the further additional subassemblies in a superordinate housing 20. The housing 20 also serves for fastening the belt retractor in a backrest of a vehicle seat or else in an elongated installation space of a vehicle structure. The electric motor 5 is provided for a reversible belt tightening and different other comfort functions, for example, as a winding aid, as a spring adjustment or as a belt operator. The driving rotational movement of the electric motor 5 is translated via the transmission 4 and transmitted via a transfer bar 6 to the force-limiting device 2, which then in turn drives the belt reel 1.

In FIG. 2, the belt retractor together with the belt reel 1 and the force-limiting device 2 can be recognized in an enlarged view. The frame 8 is supported on the housing 20, which forms a vehicle-fixed abutment for the frame 8 in the position mounted on the vehicle or on the seat. The force-limiting device 2 is arranged in an orientation coaxial to the axis of rotation of the belt reel 1 on the end face of the belt reel 1 and is connected to the belt reel 1.

The force-limiting device 2 comprises a first torsion rod 9, a second torsion rod 10, a profiled head 7 and a second switchable blocking device 3. The profiled head 7 is a carrier of a blocking pawl (not shown) which forms a first blocking device and blocks the profiled head 7 during actuation of a sensor device that is sensitive to the belt strap pull-out acceleration and/or a sensor device that is sensitive to the vehicle acceleration in the pull-out direction of a safety belt (also not shown) wound onto the belt reel 1. The belt reel 1 is rotatably mounted in the frame 8, which in turn is fixed in a rotationally fixed manner in the housing 20 and can be fastened to the vehicle or in the backrest. The profiled head 7 is radially mounted with axial spacing in a web 22 fastened in the housing 20. Thus, in a departure from the basic principle used heretofore, the belt reel 1 and the profiled head 7 are mounted independently of one another and axially spaced apart from one another. The belt reel 1 in the frame 8 and the profiled head 7 in the web 22 thus have separate and axially spaced radial bearings. As a result, the subassembly made up of the belt reel 1 and the force-limiting device 2 can be mounted in a more stable configuration overall, which is advantageous in particular during the activation of the force-limiting device 2.

The belt reel 1 has a profiled receptacle 15 which is open axially toward the outer side. The first torsion rod 9 is rotationally fixed with its first end 11 in the receptacle 15 and for this purpose has an outer profile corresponding to the profile of the receptacle 15. The receptacle 15 is surrounded by an annular protrusion 17 extending away from the end face of the belt reel 1 in the axial direction. Furthermore, a torque tube 16 is provided which engages in the protrusion 17 and surrounds the first torsion rod 9. The torque tube 16 is rotationally fixed to the protrusion 17 via the switchable second blocking device 3 via two blocking pawls, wherein the blocking pawls are released according to the switching principle described in DE 199 27 427 A1.

The torque tube 16 serves simultaneously for a rotationally fixed connection of the second profiled end 12 of the first torsion rod 9 to the first profiled end 13 of the second torsion rod 10. For this purpose, the torque tube 16 has a central section with radially inwardly directed projections with which it engages in outer profiles of the second end 12 of the first torsion rod 9 and of the first end 13 of the second torsion rod 10 and thereby rotationally fixes both ends to one another.

The profiled head 7 also has a central profiled receptacle 18, which is surrounded by an annular protrusion 21 extending in the axial direction. The second end 14 of the second torsion rod 10 is provided with an outer profile corresponding to the profiling of the receptacle 18 and is fixed in a rotationally fixed manner in the receptacle 18 relative to the profiled head 7. Furthermore, the torque tube 16 surrounds the annular protrusion 21 radially on the outside and is supported on the profiled head 7. Since the profiled head 7 is in turn mounted separately from the belt reel 1, it forms a abutment for the torque tube 16 that is fixed to the frame.

In order to activate the force-limiting device 2, the profiled head 7 in a first step is blocked via a first blocking device in a fixed manner relative to the vehicle when a predetermined belt pull-out acceleration or vehicle deceleration is exceeded, wherein the exceeding of the predetermined limit values is detected by means of the sensor devices described above.

If the occupant now moves forward in the event of an accident due to inertia, the safety belt is pulled out, and the restraining force thus increases the tensile force in the safety belt. As a result, the belt reel 1 rotates in the pull-out direction of the safety belt until the further rotational movement is blocked by the blocking of the profiled head 7. Subsequently, a further belt strap pull-out is possible only when such a belt pull-out is made possible by a plastic deformation of the two torsion rods 9 and 10.

Before the second blocking device 3 is switched, the torque tube 16 is rotationally fixed to the belt reel 1, the protrusion 17, the second end 12 of the first torsion rod 9 and the first end 13 of the second torsion rod 10, so that the first torsion rod 9 is decoupled from the force flow. Thus, in this phase the second torsion rod 10 is plastically deformed about its longitudinal axis when the pull-out force of the safety belt exceeds the pull-out force defined by the force-limiting level of the second torsion rod 10. The second torsion rod 10 has a higher force-limiting level than the first torsion rod 9, so that a high force-limiting level acts in this phase of the force-limitation. In this case, the torque tube 16 rotates relative to the blocked profiled head 7 and is mounted on the annular protrusion 21 of the profiled head 7.

By switching the second blocking device 3, the connection of the torque tube 16 to the protrusion 17 is canceled. Thus, the first torsion rod 9 is then located in the force flow. Since the first torsion rod 9 has a lower force-limiting level than the second torsion rod 10, the second torsion rod 10 acts as a fixed bearing and the second end 12 of the first torsion rod 9 is also blocked by the torque tube 16 due to the connection to the first end 13 of the second torsion rod 10. As a result, the first end 11 of the first torsion rod 9 rotates relative to the blocked second end 12, and the first torsion rod 9 is plastically deformed about its longitudinal axis. The lower force-limiting level now acts. In this case, the torque tube 16 is blocked by the positive-locking connection to the first end 13 of the second torsion rod 10, and the belt reel 1 rotates relative to the torque tube 16, and the protrusion 17 of the belt reel 1 additionally forms a bearing for the torque tube 16.

The invention has been described in reference to a force-limiting device 2 having two torsion rods 9 and 10, which enable a stepped force-limiting profile. The two torsion rods 9 and 10 are arranged coaxially to one another and in series relative to one another so that the outer diameter is not increased by their arrangement. The belt retractor is thus only slightly longer.

In an alternative embodiment, the belt retractor can also be provided with a force-limiting device 2 which has only a first torsion rod 9. In this case, the second end 12 of the first torsion rod 9 is fixed in a rotationally fixed manner in the receptacle 18 of the profiled head 7. The second switchable blocking device 3, the torque tube 16 and the second torsion rod 10 can thus be omitted. In this case, the first torsion rod 9 would provide a rotationally fixed connection of the belt reel 1 to the profiled head 7 until the plastic deformation limit of the first torsion rod 9 is reached. In this exemplary embodiment too, the belt retractor would have an elongated narrow basic structure, and the belt reel 1 could be made considerably smaller in its outer diameter by the outwardly shifted first torsion rod 9. Apart from a receptacle for the end of the safety belt, the belt reel 1 could be designed as a solid shaft and thus have a maximum rigidity with the smallest possible external dimensions.

1. A belt retractor comprising
a belt reel which is rotatably mounted in a frame, and
a force-limiting device having at least one plastically deformable first torsion rod, wherein
the first torsion rod has a first end rotationally fixed to the belt reel and a second end rotationally fixed to a profiled head which can be blocked via a first blocking device in a fixed manner relative to the vehicle, wherein
the belt reel the first torsion rod and the profiled head are arranged coaxially to one another and in series relative to one another.

2. The belt retractor according to claim 1, wherein
the first torsion rod is arranged in series between the belt reel and the profiled head .

3. The belt retractor according to claim 2, wherein
the profiled head and the belt reel are mounted at an axial distance from one another in separate radial bearings.

4. The belt retractor according to claim 1, wherein
the first torsion rod is held in a rotationally fixed manner with the first end in a receptacle of the belt reel that is open toward the axial outer side.

5. The belt retractor according to claim 1, wherein
at least one second torsion rod is arranged coaxially to and in series relative to the belt reel between the first torsion rod and the profiled head.

6. The belt retractor according to claim 5, wherein
the second and the first torsion rod have different plastic deformation limits.

7. The belt retractor according to claim 5, wherein
a torque tube is provided which is fixed in relation to the belt reel in a rotationally fixed manner via a switchable second blocking device, wherein
the torque tube connects the two mutually facing ends of the first torsion rod and of the second torsion rod to each other in a rotationally fixed manner.

8. The belt retractor according to claim 7, wherein
an axially projecting protrusion is provided on the belt reel in relation to which the torque tube is fixed via the switchable second blocking device.

9. The belt retractor according to claim 8, wherein
the axial protrusion is annular, and
the torque tube projects radially inwardly into the annular protrusion or surrounds the annular protrusion radially on the outside.

10. The belt retractor according to claim 7, wherein
an axially projecting annular protrusion is provided on the profile head, and
the torque tube projects radially inwardly into the annular protrusion or surrounds the annular protrusion radially on the outside.

11. The belt retractor according to claim 1, wherein
the belt reel is designed as a solid shaft.
